(19) United States
(12) Patent Application Publication
(10) Pub. No.: US 2011/0044689 A1
(43) Pub. Date: Feb. 24, 2011

(54) METHOD AND SYSTEM FOR CROSS-PHASE-MODULATION NOISE REDUCED TRANSMISSION IN HYBRID NETWORKS

(76) Inventors: Olga I. Vassilieva, Plano, TX (US); Takao Naito, Plano, TX (US)

Correspondence Address: BAKER BOTTS L.L.P., 2001 ROSS AVENUE, SUITE 600, DALLAS, TX, 75201-2980, US

(21) Appl. No.: 12/545,704

(22) Filed: Aug. 21, 2009

(51) Int. Cl. H04J 14/06; H04J 14/02

(52) U.S. Cl. 398/65; 398/79

(57) ABSTRACT

A system for cross-phase-modulation-noise reduced transmission in hybrid networks includes a first, second, and third set of optical transmitters. The first set of optical transmitters transmits a set of ten gigabit per second signals. The second set of optical transmitters transmits a set of forty gigabit per second signals. The third set of optical transmitters transmits a set of one hundred gigabit per second signals. On a wavelength spectrum, the set of 10 G signals is immediately adjacent to the set of 100 G signals, and the set of 100 G signals is immediately adjacent to the set of 40 G signals. The set of 10 G signals and the set of 100 G signals are not separated by a guard band. In addition, the set of 100 G signals and the set of 40 G signals are also not separated by a guard band.

### TECHNICAL FIELD OF THE INVENTION

The present invention relates generally to optical communication networks and, more particularly, to a method and system for transmitting signals in hybrid networks.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss. Optical networks often employ wavelength division multiplexing (WDM) or dense wavelength division multiplexing (DWDM) to increase transmission capacity. In WDM and DWDM networks, a number of optical channels are carried in each fiber at disparate wavelengths, thereby increasing network capacity.

An optical signal comprised of disparate modulated signals can experience cross-phase-modulation noise, a phenomenon that degrades the quality of the modulated signals. Cross-phase-modulation occurs as a side effect of on-off-keying signals, which affects signals modulated with phase shifting in nearby channels.

### SUMMARY

In one embodiment, a system for cross-phase-modulation-noise reduced transmission in hybrid networks includes a first, second, and third set of optical transmitters. The first set of optical transmitters transmits a set of ten gigabit per second (10 G) signals. The second set of optical transmitters transmits a set of forty gigabit per second (40 G) signals. The third set of optical transmitters transmits a set of one hundred gigabit per second (100 G) signals. On a wavelength spectrum, the set of 10 G signals is immediately adjacent to the set of 100 G signals, and the set of 100 G signals is immediately adjacent to the set of 40 G signals. The set of 10 G signals and the set of 100 G signals are not separated by a guard band. In addition, the set of 100 G signals and the set of 40 G signals are also not separated by a guard band.

In a further embodiment, a system for cross-phase-modulation-noise reduced transmission in hybrid networks includes a first, second, and third set of optical transmitters. The first set of optical transmitters transmits a set of ten gigabit per second signals. The second set of optical transmitters transmits a set of forty gigabit per second signals. The third set of optical transmitters transmits a set of one hundred gigabit per second signals. On a wavelength spectrum, the set of 10 G signals is immediately adjacent to the set of 40 G signals, and the set of 40 G signals is immediately adjacent to the set of 100 G signals. The set of 10 G signals and the set of 40 G signals are not separated by a guard band. In addition, the set of 40 G signals and the set of 100 G signals are also not separated by a guard band.

In a further embodiment, a method of communicating over an optical network includes transmitting a set of one or more ten gigabit per second signals, a set of one or more forty gigabit per second signals, and a set of one or more one hundred gigabit per second signals. The set of 10 G signals is transmitted on a wavelength immediately adjacent to the set of 100 G signals, and the set of 40 G signals is transmitted on a wavelength immediately adjacent to the set of 100 G signals. The set of 10 G signals and the set of 100 G signals are not separated by a guard band. Further, the set of 40 G signals and the set of 100 G signals are not separated by a guard band.

In a further embodiment, a method of communicating over an optical network includes transmitting a set of one or more ten gigabit per second signals, a set of one or more forty gigabit per second signals, and a set of one or more one hundred gigabit per second signals. The set of 10 G signals is transmitted on a wavelength immediately adjacent to the set of 40 G signals, and the set of 40 G signals is transmitted on a wavelength immediately adjacent to the set of 100 G signals. The set of 10 G signals and the set of 40 G signals are not separated by a guard band. Further, the set of 40 G signals and the set of 100 G signals are not separated by a guard band.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating one embodiment of an optical network carrying a signal comprising a plurality of sets of channels using at least two different modulation formats;

FIG. 2 is a diagram of the channel mapping of a typical hybrid optical signal;

FIG. 3 is a diagram of the channel mapping of an example embodiment comprising 10 gigabit/s (10 G) on-off-keyed (OOK) channels, 40 gigabit/s (40 G) phase-shift-keyed (PSK) channels, and 100 gigabit/s (100 G) PSK channels.

FIG. 4 is a diagram of the channel mapping of an example embodiment comprising 10 G OOK channels, 40 G OOK channels, and 100 G PSK channels;

FIG. 5 is a diagram of the channel mapping of an example embodiment comprising 10 G PSK channel, 100 G PSK channels, and 40 G OOK channels; and

FIG. 6 is a diagram of the channel mapping of an example embodiment comprising 10 G PSK channels, 40 G OOK channels, and 100 G OOK channels.

### DETAILED DESCRIPTION

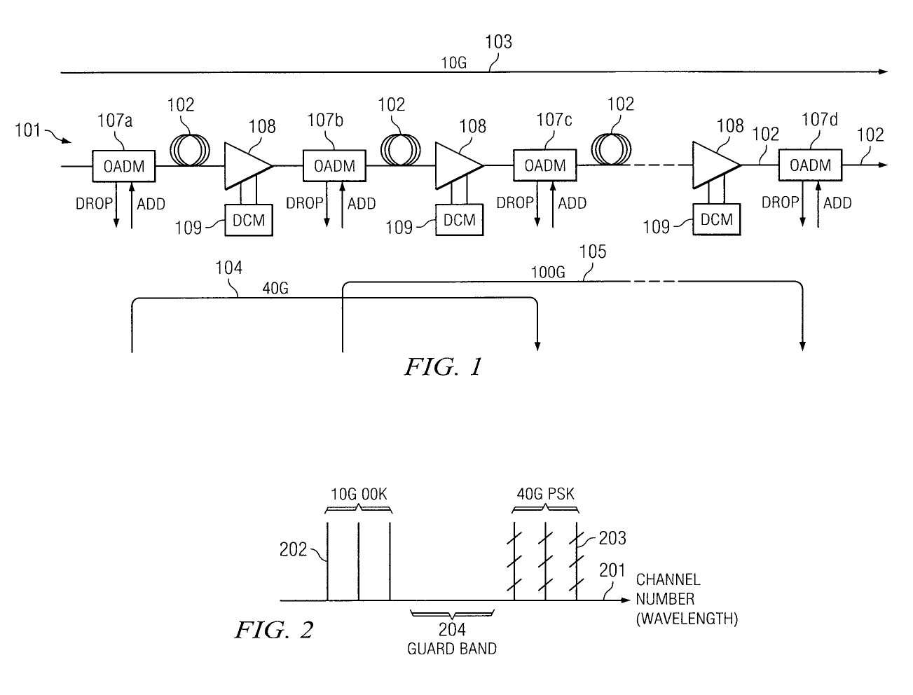

FIG. 1 illustrates an example optical network 101. The optical network 101 may include one or more optical fibers 102 operable to transport one or more optical signals 103, 104, 105 communicated by components of the optical network 101. The components of optical network 101, coupled together by the optical fibers 102, may include one or more optical add/drop multiplexers (OADM) 107, one or more amplifiers 108, and one or more dispersion compensation modules 109. Optical network 101 may be a point-to-point optical network with terminal nodes, a ring optical network, a mesh optical network, or any other suitable optical network or combination of optical networks. The optical network 101 may be used in a short-haul metropolitan network, a long-haul inter-city network, or any other suitable network or combination of networks. Optical fibers 102 comprise any suitable type of fiber, such as a Single-Mode Fiber (SMF), Enhanced Large Effective Area Fiber (E-LEAF), or TrueWave® Reduced Slope (TW-RS) fiber

Optical network 101 may include devices operable to transmit optical signals over optical fibers 102. Information is transmitted and received through optical network 101 by modulation of one or more wavelengths of light to encode the information on the wavelength. In optical networking, a wavelength of light is also referred to as a channel. OADM multiplexers 107 may include any multiplexer or combination of multiplexers or other devices operable to combine different channels into one signal. For example, OADM multiplexers 107 may comprise a wavelength selective switch (WSS). OADM multiplexers 107 may be operable to receive and combine the disparate channels transmitted across optical network 101 into an optical signal for communication along fibers 102.

Amplifier 108 may be used to amplify the multi-channeled signal. Amplifier 108 may be positioned before and/or after certain lengths of fiber 102. Amplifier 108 26 may comprise an optical repeater that amplifies the optical signal. This amplification may be performed without opto-electrical or electro-optical conversion. In some embodiments, amplifier 108 may comprise an optical fiber doped with a rare-earth element. When a signal passes through the fiber, external energy is applied to excite the atoms of the doped portion of the optical fiber, which increases the intensity of the optical signal. As an example, amplifier 108 may comprise an erbium-doped fiber amplifier (EDFA). However, any other suitable amplifier 108 may be used.

The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in networks would be limited to the bit rate of solely one wavelength. With more bandwidth, optical networks are capable of transmitting greater amounts of information. Referring back to FIG. 1, optical network 101 is operable to transmit disparate channels using WDM, DWDM, or some other suitable multi-channel multiplexing technique, and to amplify the multi-channel signal.

As discussed above, the amount of information that can be transmitted over an optical network varies directly with the number of optical channels coded with information and multiplexed into one signal. Therefore, an optical signal employing WDM may carry more information than an optical signal carrying information over solely one channel. An optical signal employing DWDM may carry even more information. Besides the number of channels carried, another factor that affects how much information can be transmitted over an optical network is the bit rate of transmission. The greater the bit rate, the more information may be transmitted.

Improvements and upgrades in optical network capacity generally involve either increasing the number of wavelengths multiplexed into one optical signal or increasing bit rates of information traveling on each wavelength. In either case, it is usually more cost-efficient to use, modify, or add to existing network components than to replace the entire optical system. For reasons relating to the cost of upgrading an optical system, upgrades sometimes occur in stages in which the network must support both new technologies that provide greater bandwidth and old technologies that provide less bandwidth.

Today, many existing networks transmit information at ten gigabits per second (GB/s) and modulate the information using an on-off-keying technique (OOK). Two examples of OOK include a non-return-to-zero (NRZ) modulation technique or alternatively a return-to-zero technique (RZ). In addition, information may be transmitted at forty or one hundred GB/s using OOK. Signal transmission upgrades include, for example, transmitting information at forty or one hundred GB/s using phase-shift-keying (PSK). In addition, information may be transmitted via a ten GB/S PSK technique. Many different kinds of PSK techniques exist, including differential-phase-shift-keying (DPSK), differential-quadrature-phase-shift-keying (DQPSK), dual-polarization-quadrature-phase-shift-keying, orthogonal-frequency-division-multiplexing-phase-shift-keying, and optical-frequency-division-multiplexing-subcarrier-multiplexing to modulate and multiplex the optical signal. Since upgrading the entire optical network's transmitters would be cost-prohibitive for most optical network operators, many such operators have instead desired to upgrade their networks by incrementally replacing, for example, existing ten GB/s NRZ transmitters with forty or one hundred GB/s PSK transmitters.

One challenge faced by those wishing to implement the cost-efficient strategy of integrating upgraded transmitters with existing transmitters is the challenge of cross phase modulation noise. Power variations in an OOK channel can cause a non-linear phase shift in neighboring signals. Further, it is difficult to predict which bits in a signal will experience what degree of phase shift.

Referring back to FIG. 1, a signal transmitted may include different sets of channels using different modulation formats. In particular, the WDM signal may comprises a set of channels communicating information at ten GB/s, a set of channels communicating information at forty GB/s, and a set of channels communicating information at one hundred GB/s. However, the sets of disparate channels may communicate information at any suitable bit rate and/or using any suitable modulation technique. For example, one or more of the channels may communicate information at a rate of ten, twenty, forty, eighty, one hundred GB/s, or any other suitable bit rate. One or more of the channels may additionally communicate information using the modulation techniques discussed above. As used herein, a “set” of channels may include one or more channels and does not imply any spatial or any other unspecified relationship among the channels (for example, the channels in a set need not be contiguous). In addition, as used herein, “information” may include any information communicated, stored, or sorted in the network. This information may have at least one characteristic modulated to encode audio, video, textual, real-time, non-real-time and/or other suitable data. Additionally, information communicated in optical network 101 may be structured in any appropriate manner including, but not limited to, being structured as frames, packets, or an unstructured bit stream.

The multi-channel signal is transmitted over optical fibers 102 to OADMs 107. The optical fibers 102 may include, as appropriate, a single, unidirectional fiber; a single, bi-directional fiber; or a plurality of uni- or bi-directional fibers. Although this description focuses, for the sake of simplicity, on an embodiment of the optical network 101 that supports unidirectional traffic, the present invention further contemplates a bi-directional system that includes appropriately modified embodiments of the components described below to support the transmission of information in opposite directions along the optical network 101.

OADMs 107 comprise an add/drop module, which may include any device or combination of devices operable to add and/or drop optical signals from fibers 102. The add/drop module may also include any device or combination of devices operable to complete optical dispersion compensation in one or more sets of channels in an optical signal for which dispersion compensation was not completed by the associated DCM 109. Each OADM 107 may be coupled to an amplifier 108 and associated optical dispersion compensating module 109 (DCM). Amplifiers 108 may be used to amplify the WDM signal as it travels through the optical network 101. DCMs 109 include any dispersion compensating fiber (DCF) or other dispersion compensating device operable to perform optical dispersion compensation on a signal or set of channels comprising a signal that use one modulation technique. After a signal passes through OADM 107, the signal may travel along fibers 102 directly to a destination, or the signal may be passed through one or more additional OADMs 107 before reaching a destination. As described above, amplifier 108 may be used to amplify the signal as it travels through the optical network 101, and DCM 109 may perform optical dispersion compensation on a set of channels comprising a signal that use one modulation technique. Although the optical network 101 shows DCM 109 coupled to a respective amplifier 108, the DCM 109 may also be positioned separately from amplifier 108.

In operation, optical network 101 may transmit information at different bit rates and/or using different modulation techniques over different channels. These different channels may be multiplexed into an optical signal and communicated over optical fiber 102. An amplifier 108 receives the optical signal, amplifies the signal, and passes the signal over optical fiber 102. Optical fiber 102 transports the signal to the next component. Again, amplifier 108 may be positioned separately from, either before or after, a DCM 109.

DCM 109 receives the signal and performs optical dispersion compensation on the signal. After the DCM 109 performs optical dispersion compensation on the signal and the signal is forwarded, OADM 107 may receive the signal. After receiving the optical signal, the add/drop module of OADM 107 may drop channels from the optical signal and/or add channels to the optical signal. The OADM 107 may also complete optical dispersion compensation on the channels for which dispersion was not completed by the DCM 109.

In the example embodiment of FIG. 1, a ten GB/s channel 103 is received at OADM 107a from a previous node in optical network 101 (not illustrated). OADM 107a adds a forty GB/s channel 104 to the signal, and then OADM 107b adds a one hundred GB/s channel 105 to the signal. Then, OADM 107c drops the forty GB/s channel 104 from the signal, and OADM 107d drops the one hundred GB/s channel from the signal. FIG. 1 shows only one example of how sets of channels of different rates and modulations may be added to the signal of optical network 101. Channels and sets of channels may be added or removed in any order. Portions of optical network 101 may have one or more sets of channels representing different rates and modulations.

As noted above, although the optical network 101 is shown as a point-to-point optical network with terminal nodes, the optical network 101 may also be configured as a ring optical network, a mesh optical network, or any other suitable optical network or combination of optical networks.

It should be noted that although particular components have been shown, modifications, additions, or omissions may be made to the optical network 101 without departing from the scope of the invention. The components of the optical network 101 may be integrated or separated according to particular needs. Moreover, the operations of the optical network 101 may be performed by more, fewer, or other components.

An optical multiplexed signal comprised of disparate modulated signals can experience cross-phase-modulation noise, a phenomenon that degrades the quality of the modulated signals. Cross-phase-modulation occurs when two or more channels are transmitted simultaneously inside the fiber by using different carrier frequencies. Cross-phase-modulation induced by on-off-keying signals significantly affects signals modulated with phase shifting in nearby channels. This problem can be addressed by wavelength assignment schemes. For example, each channel may be assigned particular wavelengths, and some channels may be left empty between wavelength assignments, creating a guard band.

FIG. 2 illustrates an example of mapping of channel sets (wavelength assignment) to avoid cross-phase modulation noise in a typical arrangement by which OOK channels and PSK channels are transmitted through an optical network. 10 G OOK channels 202 and 40 G PSK channels 203 are distributed along a wavelength spectrum 201 so as to address cross-phase-modulation noise. A guard band 204 is used to separate the channels transmitting the 10 G OOK channel 202 and the 40 G PSK channel 203, to counter the effects of cross-phase modulation induced noise by the OOK channel. No signals are transmitted in the wavelengths corresponding to the guard band. The bandwidth of the guard band will vary between different implementation, but at a minimum is the necessary size to substantially reduce cross-phase modulation noise between multiple fiber optic signals such as the 10 G OOK channel 202 and 40 G PSK channel 203. For example, if the channel spacing in FIG. 2 is fifty gigahertz, then the guard band could be as large as 200 or 300 gigahertz. However, nothing may be transmitted on these wavelengths, meaning that the guard band wastes bandwidth which may otherwise be used for transmitting an optical signal.

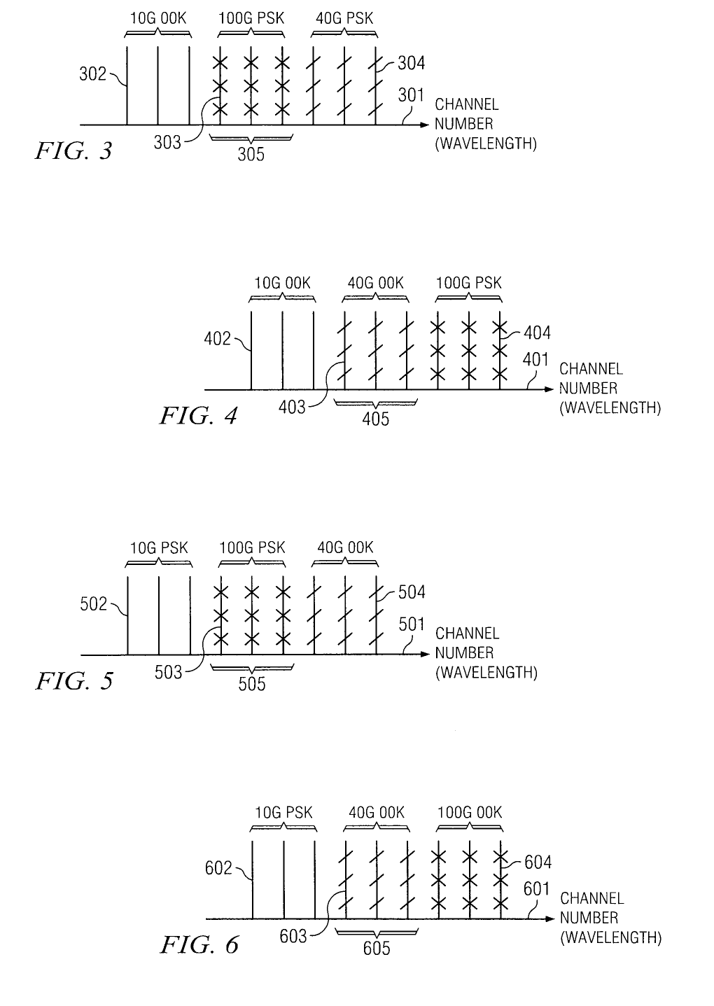

Particular embodiments of the present disclosure address some of these challenges by mapping channels that minimize the effects of cross-phase-modulation noise between OOK and PSK channels. A number of mappings may be used, and FIGS. 3-6 describe particular embodiments as examples.

FIG. 3 illustrates an example embodiment for transmitting one or more 10 G OOK channels, 100 G PSK channels, and 40 G PSK channels through an optical network. Along a wavelength spectrum 301, 10 G OOK channels 302, 100 G PSK channels 303, and 40 G PSK channels 304 may be distributed. As can be seen, a guard band is not needed, and thus the bandwidth 305 necessary for a guard band may be used to transmit optical signals. In one embodiment, the 10 G OOK channel 302 may be return-to-zero or no-return-to-zero. In one embodiment, the 100 G PSK channel 303 comprises a fifty gigabaud DQPSK channel. In one embodiment, then 40 G PSK channel 304 comprises a twenty gigabaud DQPSK channel. The signals in the 100 G PSK channel 303 experience smaller cross-phase-modulation noise from the signals in the 10 G OOK channel 302 compared to the cross-phase-modulation noise experienced by a 40 G PSK signal occupying the channels of the 100 G PSK channel 303. There is little to no cross-phase-modulation noise between adjacent 40 G PSK and 100 G PSK channels.

FIG. 4 illustrates an example embodiment for transmitting one or more 10 G OOK channels, 40 G OOK channels, and 100 G PSK channels through an optical network. Along a wavelength spectrum 401, 10G OOK channels 402, 40 G OOK channels 403, and 100 G PSK channels 404 may be distributed. As can be seen, a guard band is not needed, and thus the bandwidth 405 necessary for a guard band may be used to transmit optical signals. In one embodiment, the 10 G OOK channel 402 may be return-to-zero or no-return-to-zero. In one embodiment, the 40 G OOK channel 403 may be return-to-zero or no-return-to-zero. In one embodiment, the 40 G OOK channel 403 may comprise one or more twenty gigabaud orthogonal frequency division multiplexing subcarrier-multiplexing channels. In one embodiment, the 100 G PSK channel 404 comprises a fifty gigabaud DQPSK channel. The signals in the 100 G PSK channel 404 experience smaller cross-phase-modulation noise from the signals in the adjacent 40 G OOK channel 403, compared to the cross-phase-modulation noise that the 100 G PSK channel 404 would experience if the 10 G OOK channel 402 and the 100 G PSK channel 404 were adjacent.

FIG. 5 illustrates an example embodiment for transmitting one or more 10 G PSK channels, 100 G PSK channels, and 40 G OOK channels through an optical network. Along a wavelength spectrum 501, 10 G PSK channels 502, 100 G PSK channels 503, and 40 G OOK channels 504 may be distributed. As can be seen, a guard band is not needed, and thus the bandwidth 505 necessary for a guard band may be used to transmit optical signals. In one embodiment, the 40 G OOK channel 504 may be return-to-zero or no-return-to-zero. In one embodiment, the 40 G OOK channel 504 may comprise one or more ten gigabaud orthogonal frequency division multiplexing subcarrier-multiplexing channels. In one embodiment, the 100 G PSK channel 503 may comprise a fifty gigabaud DQPSK channel. The signals in the 100 G PSK channel 503 experience a low cross-phase-modulation noise from the signals in the 10 G PSK channel 502. The signals in the 100 G PSK channel 503 also experience lower cross-phase-modulation noise from the 40 G OOK channel 504 compared to the cross-phase-modulation noise that would be experienced by a 10 G PSK signal occupying the channels of the 100 G PSK channel 503. There is little to no cross-phase-modulation noise between adjacent 10 G PSK and 100 G PSK channels.

FIG. 6 illustrates an embodiment of the present invention for transmitting one or more 10 G PSK channels, 40 G OOK channels, and 100 G OOK channels through an optical network. Along a wavelength spectrum 601, 10 G PSK channels 602, a 40 G OOK channels 603, and a 100 G OOK channels 604 may be distributed. As can be seen, a guard band is not needed, and thus the bandwidth 605 necessary for a guard band may be used to transmit optical signals. In one embodiment, the 40 G OOK channel 603 or 100 G OOK channel 604 may be return-to-zero or no-return-to-zero. In one embodiment, the 100 G OOK channel 604 may comprise five twenty gigabaud subcarrier multiplexing channels. The 10 G PSK channel 602 experiences less cross-phase-modulation noise from the adjacent 40 G OOK channel 603 than the 10 G PSK channel 602 would experience if it were instead adjacent to the twenty gigabaud OOK channels in the 100 G OOK channel 604.

Although the present invention has been described with several embodiments, various changes and modifications may be suggested to one skilled in the art. It is intended that the present invention encompass such changes and modifications as fall within the scope of the appended claims.

What is claimed is:

1. An optical communications network, comprising:
at least one optical fiber;
a first set of one or more optical transmitters, the first set of one or more optical transmitters transmitting over the optical fiber a first set of signals comprising one or more ten gigabit per second signals (10 G signal);
a second set of one or more optical transmitters, the second set of one or more optical transmitters transmitting over the optical fiber a second set of signals comprising one or more forty gigabit per second signals (40 G signal);
a third set of one or more optical transmitters, the third set of one or more optical transmitters transmitting over the optical fiber a third set of signals comprising one or more one hundred gigabit per second signals (100 G signal);
wherein on a wavelength spectrum the first set of 10 G signals is immediately adjacent to the third set of 100 G signals, and the third set of 100 G signals is immediately adjacent to the second set of 40 G signals;
wherein the first set of 10 G signals and the third set of 100 G signals are not separated by a guard band; and
wherein the third set of 100 G signals and the second set of 40 G signals are not separated by a guard band.

2. The network of claim 1, wherein:
the first set of 10 G signals comprises an on-off-keying signal (10 G OOK signal);
the third set of 100 G signals comprises a phase-shift-keying signal (100 G PSK signal); and
the second set of 40 G signals comprises a phase-shift-keying signal (40 G PSK signal).

3. The network of claim 1, wherein:
the first set of 10 G signal comprises a phase-shift-keying signal (10 G PSK signal);
the third set of 100 G signal comprises a phase-shift-keying signal (100 G PSK signal); and
the second set of 40 G signal comprises an on-off-keying signal (40 G OOK signal).

4. The network of claim 2, wherein:
the 100 G PSK signal comprises a 50-gigabaud differential-quadrature-phase-shift-keyed signal.

5. The network of claim 2, wherein:
the 40 G PSK signal comprises a 20-gigabaud differential-quadrature-phase-shift-keyed signal.

6. The network of claim 2, wherein:
a plurality of the phase-shift-keying signals comprises a dual-polarization-quadrature-phase-shift-keyed signal.

7. The network of claim 2, wherein:
a plurality of the phase-shift-keying signals comprises a orthogonal-frequency-division-multiplexing-phase-shift-keyed signal.

8. The network of claim 3, wherein:
the 100 G PSK signal comprises a 50-gigabaud differential-quadrature-phase-shift-keyed signal.

9. The network of claim 3, wherein:
a plurality of the phase-shift-keying signals comprises a dual-polarization-quadrature-phase-shift-keyed signal.

10. The network of claim 3, wherein:
a plurality of the phase-shift-keying signals comprises a orthogonal-frequency-division-multiplexing-phase-shift-keyed signal.

11. The network of claim 3, wherein:
the 40 G OOK signal comprises a 10-gigabaud orthogonal frequency division multiplexing subcarrier-multiplexing signals.

12. The network of claim 3, wherein:
the 40 G OOK signal comprises a 20-gigabaud orthogonal frequency division multiplexing subcarrier-multiplexing signal.

13. An optical communications network, comprising:
a first set of one or more optical transmitters, the first set of one or more optical transmitters transmitting over the optical fiber a first set of signals comprising one or more ten gigabit per second signals (10 G signal);
a second set of one or more optical transmitters, the second set of one or more optical transmitters transmitting over the optical fiber a second set of signals comprising one or more forty gigabit per second signals (40 G signal);
a third set of one or more optical transmitters, the third set of one or more optical transmitters transmitting over the optical fiber a third set of signals comprising one or more one hundred gigabit per second signals (100 G signal);
wherein on a wavelength spectrum the first set of 10 G signals is immediately adjacent to the second set of 40 G signals, and the third set of 40 G signals is immediately adjacent to the set of 100 G signals;
wherein the first set of 10 G signals and the second set of 40 G signals are not separated by a guard band; and
wherein the second set of 40 G signals and the third set of 100 G signals are not separated by a guard band.

14. The network of claim 13, wherein:
the first set of 10 G signals comprises an on-off-keying signal (10 G OOK signal);
the second set of 40 G signals comprises an on-off-keying signal (40 G OOK signal); and
the third set of 100 G signals comprises a phase-shift-keying signal (100 G PSK signal).

15. The network of claim 13, wherein:
the first set of 10 G signals comprises a phase-shift-keying signal (10 G PSK signal);
the second set of 40 G signals comprises an on-off-keying signal (40 G OOK signal); and
the third set of 100 G signals comprises an on-off-keying signal (100 G OOK signal).

16. The network of claim 14, wherein:
the 100 G PSK signal comprises a 50-gigabaud differential-quadrature-phase-shift-keyed signal.

17. The network of claim 14, wherein:
the 100 G PSK signal comprises a dual-polarization-quadrature-phase-shift-keyed signal.

18. The network of claim 14, wherein:
the 100 G PSK signal comprises a orthogonal-frequency-division-multiplexing-phase-shift-keyed signal.

19. The network of claim 14, wherein:
the 40 G OOK signal comprises a 20-gigabaud optical-frequency-division-multiplexing/subcarrier-multiplexing signal.

20. The network of claim 15, wherein:
the 10 G PSK signal and the 40 G OOK signal are separated by a small guard band; and
the 40 G OOK signal and the 100 G OOK signal are separated by a small guard band.

21. The network of claim 15, wherein:
the 100 G OOK signal comprises a plurality of subcarrier-multiplexing signals.

22. A method of communicating over an optical network, comprising:
transmitting a first set of one or more ten gigabit per second signals (10 G signal), a second set of one or more forty gigabit per second signals (40 G signal), and a third set of one or more one hundred gigabit per second signals (100 G signal);
wherein the first set of 10 G signals is transmitted on a wavelength immediately adjacent to the third set of 100 G signals, and the second set of 40 G signals is transmitted on a wavelength immediately adjacent to the third set of 100 G signals;
wherein the first set of 10 G signals and the third set of 100 G signals are not separated by a guard band; and
wherein the second set of 100 G signals and the third set of 40 G signals are not separated by a guard band.

23. The method of claim 22, wherein
the first set of 10 G signals comprises an on-off-keying signal (10 G OOK signal);
the third set of 100 G signals comprises a phase-shift-keying signal (100 G PSK signal); and
the second set of 40 G signals comprises a phase-shift-keying signal (40 G PSK signal).

24. The network of claim 22, wherein:
the first set of 10 G signals comprises a phase-shift-keying signal (10 G PSK signal);
the third set of 100 G signals comprises a phase-shift-keying signal (100 G PSK signal); and
the second set of 40 G signals comprises an on-off-keying signal (40 G OOK signal).

25. A method of communicating over an optical network, comprising:
transmitting a first set of one or more ten gigabit per second signals (10 G signal), a second set of one or more forty gigabit per second signals (40 G signal), and a third set of one or more one hundred gigabit per second signals (100 G signal);
wherein the first set of 10 G signals is transmitted on a wavelength immediately adjacent to the second set of 40 G signals, and the second set of 40 G signals is transmitted on a wavelength immediately adjacent to the third set of 100 G signals;
wherein the first set of 10 G signals and the second set of 40 G signals are not separated by a guard band; and
wherein the second set of 40 G signals and the third set of 100 G signals are not separated by a guard band.

26. The method of claim 25, wherein
the first set of 10 G signals comprises an on-off-keying signal (10 G OOK signal);
the second set of 40 G signals comprises an on-off-keying signal (40 G OOK signal); and
the third set of 100 G signals comprises a phase-shift-keying signal (100 G PSK signal).

27. The method of claim 25, wherein:
the first set of 10 G signals comprises a phase-shift-keying signal (10 G PSK signal);
the second set of 40 G signals comprises an on-off-keying signal (40 G OOK signal); and
the third set of 100 G signals comprises an on-off-keying signal (100 G OOK signal).
